(19) United States
(12) Patent Application Publication
(10) Pub. No.: US 2014/0118104 A1
(43) Pub. Date: May 1, 2014

(54) Low Energy Communication of Medical Monitoring Information

(71) Applicant: ABBOTT DIABETES CARE INC., Alameda, CA (US)

(72) Inventors: Jeffery M. Sicurello, Union City, CA (US); Glenn Howard Berman, Alameda, CA (US)

(73) Assignee: ABBOTT DIABETES CARE INC., Alameda, CA (US)

(21) Appl. No.: 13/665,049

(22) Filed: Oct. 31, 2012

(51) Int. Cl. G05B 23/02

(52) U.S. Cl. 340/3.1

(57) ABSTRACT

Methods, systems, and devices for low energy communication of medical testing information are provided. Low energy communication of medical testing information may include detecting an analyte sample, determining an analyte concentration associated with the detected analyte sample, and transmitting an indication of the analyte concentration to an external device using a low energy wireless communication protocol. Transmitting an indication of the analyte concentration to an external device using a low energy wireless communication protocol may include generating an audio indication of the analyte concentration, packetizing the audio indication, and transmitting the packetized audio indication.

### TECHNICAL FIELD

The embodiments herein relate in general to a device and method for determining and reporting glucose readings in wireless personal area networks for diabetics.

### BACKGROUND

The number of diagnosed cases of diabetes continues to increase in the U.S. and throughout the world, creating enormous economic and public health consequences. Devices and therapies that improve the quality of life for the diabetic patient thus are important not only for the patient, but for society at large. One area in which recently developed technologies have been able to improve the standard of care has been in the maintenance of tight control over the blood glucose levels. It is well known that if a diabetic patient's blood glucose values can be maintained in a relatively narrow and normal range of from about 80 milligrams per deciliter (mg/dL) to about 120 mg/dL, the physiologically damaging consequences of unchecked diabetes can be minimized. With better blood glucose information, diabetic patients can better exercise tight control of their blood glucose level through a variety of means, including diet, exercise, and medication. For this reason a large industry has developed to provide the diabetic population with ever more convenient and accurate ways to measure blood glucose. There are many forms of these measuring devices; one common type is represented by hand-held electronic meters which receive blood samples via enzyme-based “test strips”. In using these systems, the patient lances a finger or alternate body site to obtain a blood sample, the strip is inserted into a test strip opening in the meter housing, the sample is applied to the test strip and the electronics in the meter convert a current generated by the enzymatic reaction in the test strip to a blood glucose value. The result is displayed on the (typically) liquid crystal display of the meter. Usually, this display must be large so that diabetics, who often have deteriorating vision, can more easily see the result.

It is known that such hand-held meters can advantageously be manufactured to include wireless communication capability. Such capability can assist the user in downloading data to a home computer or to a handheld computing device, for example. This minimizes the need for the user to write down data and transfer it later to an electronic record.

It is also known that hand-held meters are often given to users, so that suppliers of the strips used with the meters can generate greater strip sales. This makes the cost of the hand-held meters critical to profitability of the manufacturers. If the cost of a meter is relatively high, profits from the sale of strips will be small or worse yet, non-existent. If the cost of the meter can be reduced, profitability is improved.

Lastly, it is well known that if a strip and meter system is convenient to use, patients will test more often and compliance with treatment programs will improve. Including wireless communication in the meter adds convenience, but at a cost. For these reasons, there is a continuing need for a low cost meter and strip glucose monitoring system that nevertheless has highly convenient features, including wireless communication capabilities.

### BRIEF SUMMARY

In view of the foregoing, in accordance with the various embodiments of the present disclosure, there are provided methods, devices, and systems for providing low energy communication of medical testing information detected using a health monitor device.

In a first aspect, the present disclosure provides a device, including a housing, a processor coupled to the housing, a low energy wireless transmission unit, and a memory device coupled to the housing and the processor, wherein the memory device includes instructions which, when executed by the processor, cause the processor to detect an analyte sample, determine an analyte concentration associated with the detected analyte sample, and cause the low energy wireless transmission unit to transmit an indication of the analyte concentration to an external device.

In some embodiments of the first aspect, the low energy wireless transmission unit includes a Bluetooth® low energy unit.

In some embodiments of the first aspect, the indication of the analyte concentration includes a value indicating the analyte concentration.

In some embodiments of the first aspect, the memory device includes instructions to cause the processor to generate an audio indication of the analyte concentration, wherein the indication of the analyte concentration includes the audio indication.

In some embodiments of the first aspect, the memory device includes instructions to cause the processor to packetize the audio indication to generate a plurality of application layer packets such that each packet in the plurality of application layer packets includes a portion of the audio indication; and wherein causing the low energy wireless transmission unit to transmit the indication of the analyte concentration includes causing the low energy wireless transmission unit to transmit the plurality of application layer packets such that the external device can present the audio indication.

In some embodiments of the first aspect, the audio indication includes a voice output.

In some embodiments of the first aspect, the memory device includes instructions to cause the processor to generate the voice output such that a tone of voice of the voice output indicates a degree of urgency.

In some embodiments of the first aspect, the memory device includes instructions to cause the processor to cause the low energy wireless transmission unit to transmit the indication of the analyte concentration to the external device using a low energy wireless transmission protocol.

In a second aspect, the present disclosure provides a method including detecting an analyte sample, determining an analyte concentration associated with the detected analyte sample, and transmitting an indication of the analyte concentration to an external device using a low energy wireless communication protocol.

In some embodiments of the second aspect, the low energy wireless communication protocol includes a Bluetooth® low energy wireless communication protocol.

In some embodiments of the second aspect, the indication of the analyte concentration includes a value indicating the analyte concentration.

In some embodiments of the second aspect, the method includes generating an audio indication of the analyte concentration, wherein the indication of the analyte concentration includes the audio indication.

In some embodiments of the second aspect, the method includes packetizing the audio indication to generate a plurality of application layer packets such that each packet in the plurality of application layer packets includes a portion of the audio indication; and wherein transmitting the indication of the analyte concentration includes transmitting the plurality of application layer packets such that the external device can present the audio indication.

In some embodiments of the second aspect, the audio indication includes a voice output.

In some embodiments of the second aspect, generating the voice output includes generating the voice output such that a tone of voice of the voice output indicates a degree of urgency.

It should be noted that two or more of the embodiments described herein, including those described above, may be combined to produce one or more additional embodiments which include the combined features of the individual embodiments.

These and other objects, features, and advantages of the present disclosure will become more fully apparent from the following detailed description of the embodiments, the appended claims and the accompanying drawings.

### BRIEF DESCRIPTION OF THE DRAWINGS

FIG. 1 is a schematic view showing typical data signal flow between devices of a wireless system constructed according to one embodiment of the present invention.

FIG. 2 is a schematic view showing the client device of FIG. 1.

FIG. 3 is a schematic view showing the server device of FIG. 1.

FIG. 4 is a pectoral view showing a typical client device and typical server devices.

FIG. 5 is a perspective view showing an integrated device of an alternative embodiment.

FIG. 6 is a diagram of a health monitor device in accordance with some embodiments of this disclosure.

FIG. 7 is a diagram of an example of transmitting an audio indication of health monitoring information using a low energy wireless communication protocol in accordance with some embodiments of this disclosure.

### DETAILED DESCRIPTION

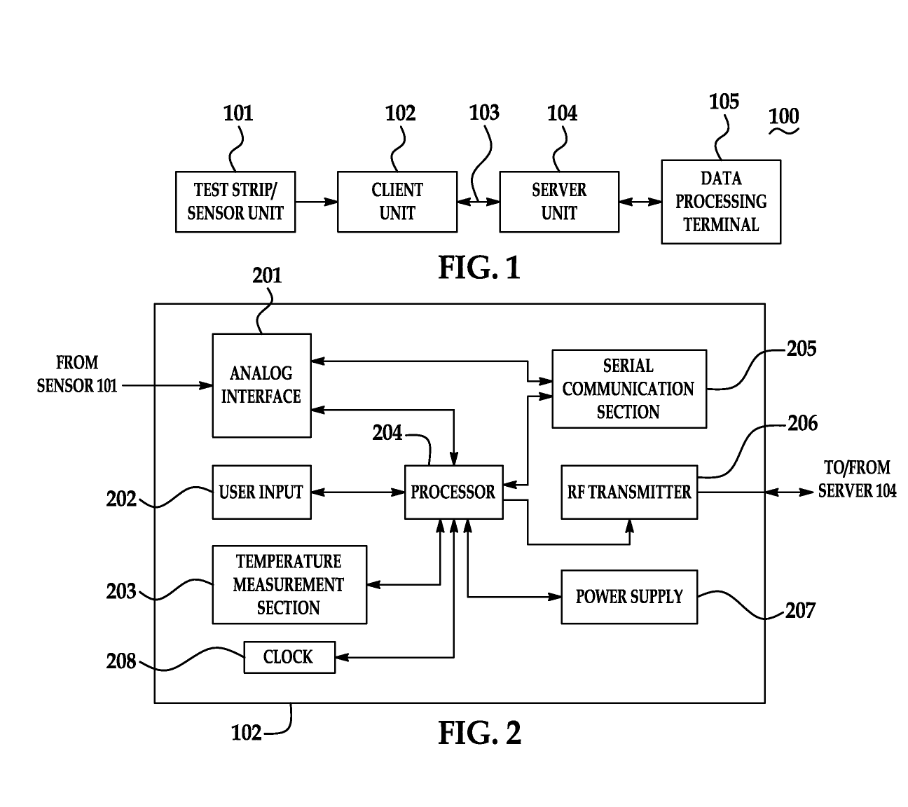

Referring to FIG. 1, a wireless system constructed according to a preferred embodiment of the present invention will be described. Test strip 101 electrically communicates with client device 102, which wirelessly communicates with server device 104, such as by two-way radio frequency (RF) contact, infrared (IR) contact, Bluetooth® contact or other known wireless means 103. Optionally, server device 104 can also communicate with other devices such as data processing terminal 105 by direct electronic contact, via RF, IR, Bluetooth® or other wireless means.

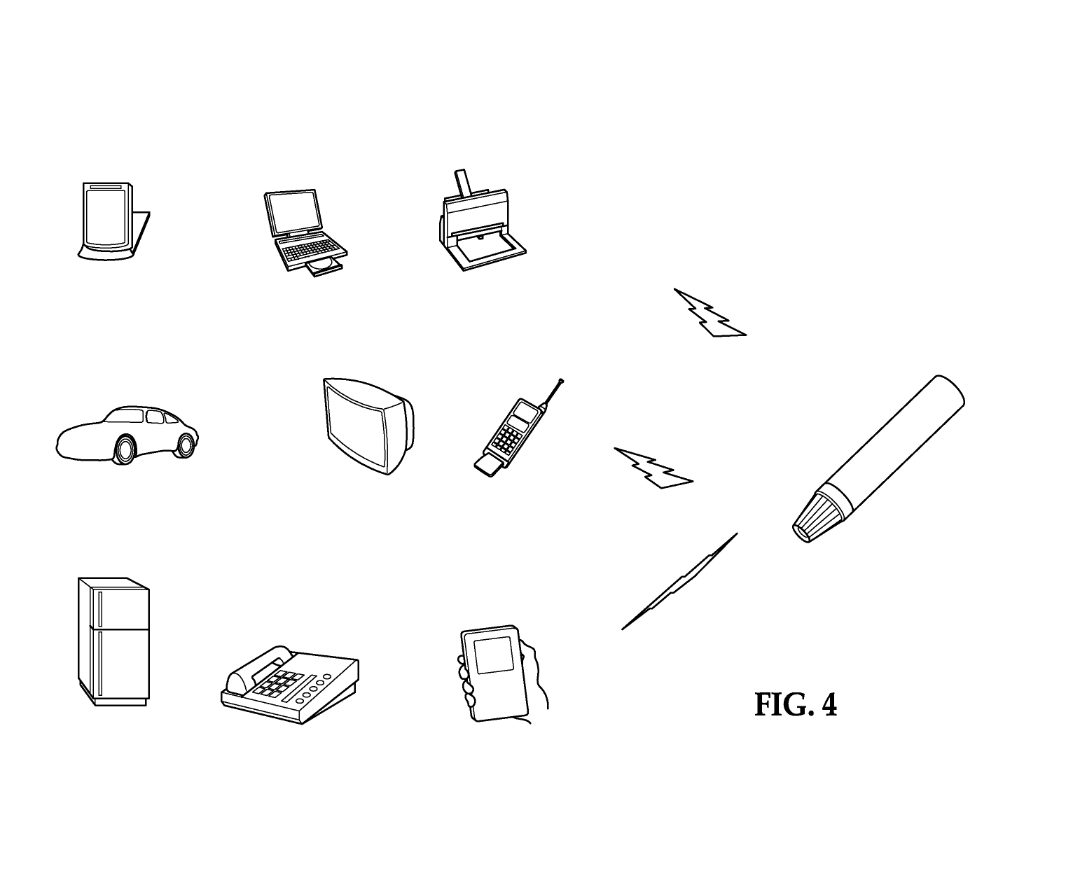

Test strip 101 is a commonly known electrochemical analyte test strip, such as a blood glucose test strip as described in U.S. patent application Ser. No. 09/434,026 filed Nov. 4, 1999 entitled “Small Volume In Vitro Analyte Sensor and Methods”, incorporated herein by reference. It is mechanically received in a test strip port of a client device 102, similar to a commonly known hand-held blood glucose meter as described in the aforementioned patent application. In the preferred embodiment, client device 102 is constructed without a user interface or display to keep the size and cost of device 102 to a minimum. Client device 102 can take the form of a highlighter or easel-sized pen, as shown in FIG. 4, and can be powered by a single AA or AAA size battery.

Client device 102 wirelessly communicates with server device 104, preferably using a common standard such as 802.11 or Bluetooth® RF protocol, or an IrDA infrared protocol. Server device 104 can be another portable device, such as a Personal Digital Assistant (PDA) or notebook computer, or a larger device such as a desktop computer, appliance, etc. as shown by the examples in FIG. 4. Preferably, server device 104 does have a display, such as a liquid crystal display (LCD), as well as an input device, such as buttons, a keyboard, mouse or touch-screen. With this arrangement, the user can control client device 102 indirectly by interacting with the user interface(s) of server device 104, which in turn interacts with client device 102 across wireless link 103.

Server device 104 can also communicate with another device 105, such as for sending glucose data from devices 102 and 104 to data storage in device 105, and/or receiving instructions or an insulin pump protocol from a health care provider computer 105. Examples of such communication include a PDA 104 synching data with a personal computer (PC) 105, a mobile phone 104 communicating over a cellular network with a computer 105 at the other end, or a household appliance 104 communicating with a computer system 105 at a physician's office.

Referring to FIG. 2, internal components of a blood glucose meter 102 of the preferred embodiment are shown. Alternatively, user input 202, such as push button(s), and other sections can be eliminated to reduce size and cost of client device 102. The glucose meter housing may contain any glucose sensing system of the type well known in the art that can be configured to fit into a small profile. Such a system can include, for example, the electrochemical glucose strip and meter sensing system sold by TheraSense, Inc. of Alameda, California under the FreeStyle® brand, or other strip and meter glucose measuring systems. The housing may thus encompass the sensor electronics and a strip connector, which connector is accessed via a test strip port opening in the housing. The housing will typically also include a battery or batteries.

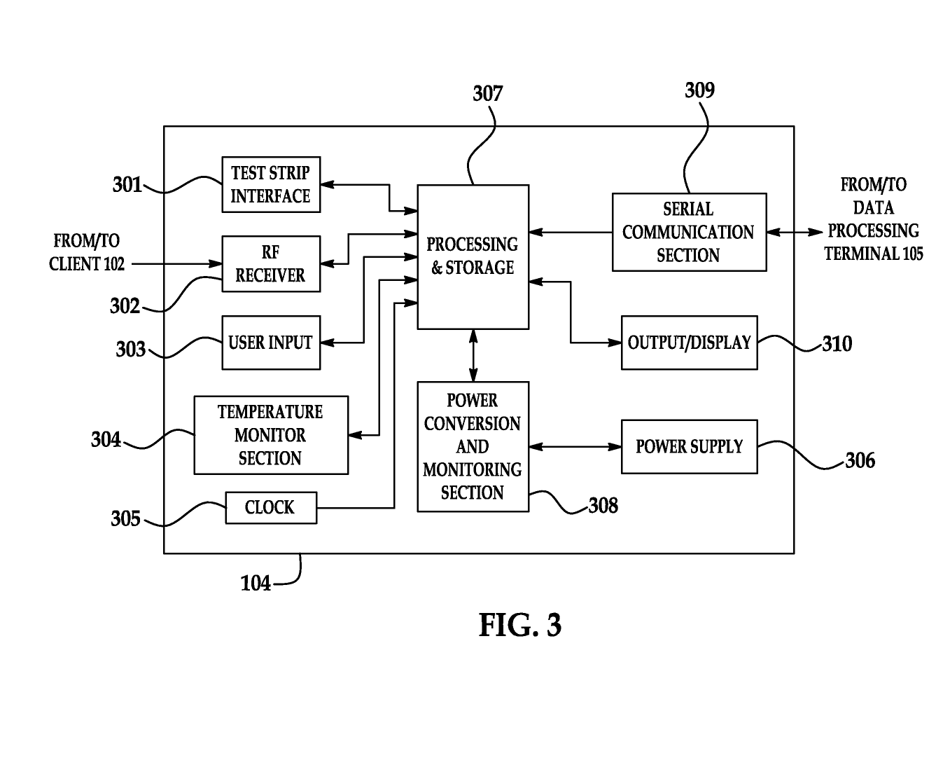

Referring to FIG. 3, internal components of a server device 104 of the preferred embodiment are shown. Note that a redundant test strip interface 301 can be provided if desired for receiving test strips 101. Device 104 can be a proprietary unit designed specifically for use with blood glucose meters, or can be a generic, multipurpose device such as a standard PDA. An example of a similar device designed for blood glucose testing is disclosed in U.S. Pat. No. 6,560,471 issued May 6, 2003 to TheraSense, Inc. entitled “Analyte Monitoring Device and Methods of Use”, incorporated herein by reference.

FIG. 4 shows examples of the devices to and from which the meter of the invention can communicate. Such devices will become part of an individual's personal area network and each becomes enabled with short range wireless communication capabilities. Desktop, laptop and handheld computers, as well as printers can be so enabled and will provide displays and printouts valuable as records for the diabetic. Telephones will also be enabled in this fashion and can be used for displaying glucose data as well as further transmitting the data over larger networks. Many of these devices can assist the diabetic by responding to glucose levels by providing alarms, or suggesting that action be taken to correct a hypo or hyperglycemic condition, or to call necessary medical assistance. Diabetics are aware of the risks involved in driving when glucose levels are out of range and particularly when they are too low. Thus, the navigation computer in the diabetic's car may become part of the local area network and will download glucose data from the meter when the diabetic enters the car. For safety sake, the car computer system may be programmed to require that the diabetic perform a glucose test before driving, and more specifically the car may be disabled unless the diabetic takes the test and the result is in an appropriate range.

The pen shaped client device 102 shown in FIG. 4 preferably has a test strip port 201 (not shown in FIG. 4) located on its distal end. Because the sensitive analog “front end” circuitry associated with measuring the very small electrochemistry currents from test strips 101 is located adjacent strip port 201, it is advisable to not design a wireless link antenna too close to this distal end as it may interfere with the proper operation of the glucose sensing circuitry. On the other hand, if the wireless link antenna is located at the proximal end of the client device 102, it will likely be covered by the hand of the user holding it, which may limit the range of the low transmission power device to an unacceptable distance. Accordingly, it is preferable to design the layout of client device 102 such that an internal antenna is located in a middle section of the device away from the distal and proximal ends.

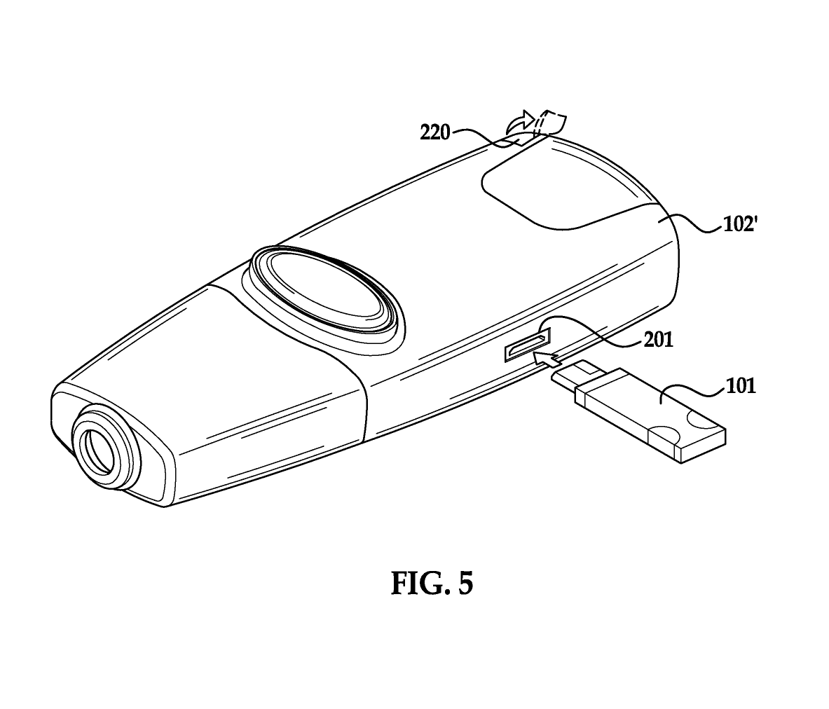

Referring to FIG. 5, an alternative embodiment of the present invention is shown. Due to the reduced size of a blood glucose meter 102 when it does not include a display or push buttons, it can be combined with a lancing device to form an integrated unit 102′. Test strip port 201 can be located in the side of integrated device 102′ or wherever there is room available. A test strip storage compartment can also be located within integrated device 102′ and accessed through a flip-lid 220 or other suitable closure means. If room permits, a second test strip storage compartment (not shown) can be included so that fresh strips and used strips can be separately stored. Preferably, a desiccant is provided in one of the storage compartments to preserve the fresh strips. The design and use of lancing devices is described in U.S. Pat. No. 6,283,982 issued to TheraSense, Inc. on Sep. 4, 2001 entitled “Lancing Device and Method of Sample Collection”, incorporated herein by reference. By integrating these features together in a single device without a user interface, the typical test kit that is carried around by people with diabetes can be made much smaller, easier to handle, and less costly.

Thus, one of the important features of the invention is reliance of the “displayless” glucose meter unit on a separate display device in order to minimize the complexity and cost of the meter unit. This permits the user to use the larger display units within his or her personal area network, all of which can be synchronized as they interact and communicate with the wireless enabled meter. When the meter is used, the sequences through which the user must “step” to complete the test are readily viewed on the larger display units (e.g. entering the calibration code, prompting application of the sample). At the same time the meter unit is simplified, smaller and less expensive to manufacture. Additionally, control buttons that are found on typical glucose meters can be eliminated, saving additional size and cost, since the user can rely on the user in out features of the server device instead. It is expected that the simplified, wireless enabled meters of the invention may ultimately become inexpensive enough to make them disposable after a specified number of uses, permitting the producer to routinely upgrade as appropriate.

Additionally, the system permits the user to include security coding at any time the meter unit accesses a display device, so that the user's data is secure. That is, it is considered an important feature of the invention that when the “client” meter of the invention is used, that the system will require the user to enter an identity code in order to verify that the person handling the meter is indeed an authorized user. Of course, it is possible for the system to permit more than one user if the meter owner so desires. Moreover, the user's data may optionally be encrypted prior to wireless transmission and thereafter respectively decrypted upon wireless reception.

While the module need not include a large or expensive display, it may nevertheless be advantageous to include some ability to advise the user of a glucose level which is determined when the module is used as a “stand-alone” unit. For example, the module could include a very low cost, small three digit LCD display. Alternatively, the module could include LED indicator lights (e.g. red for out of desired range, green for within desired range). Other possibilities include a red LED for below range, a green LED for within range, and a yellow LED for above range, or a column of LEDs or an electroluminescent strip (similar to those used on common batteries to indicate battery life) to indicate approximate or relative glucose levels.

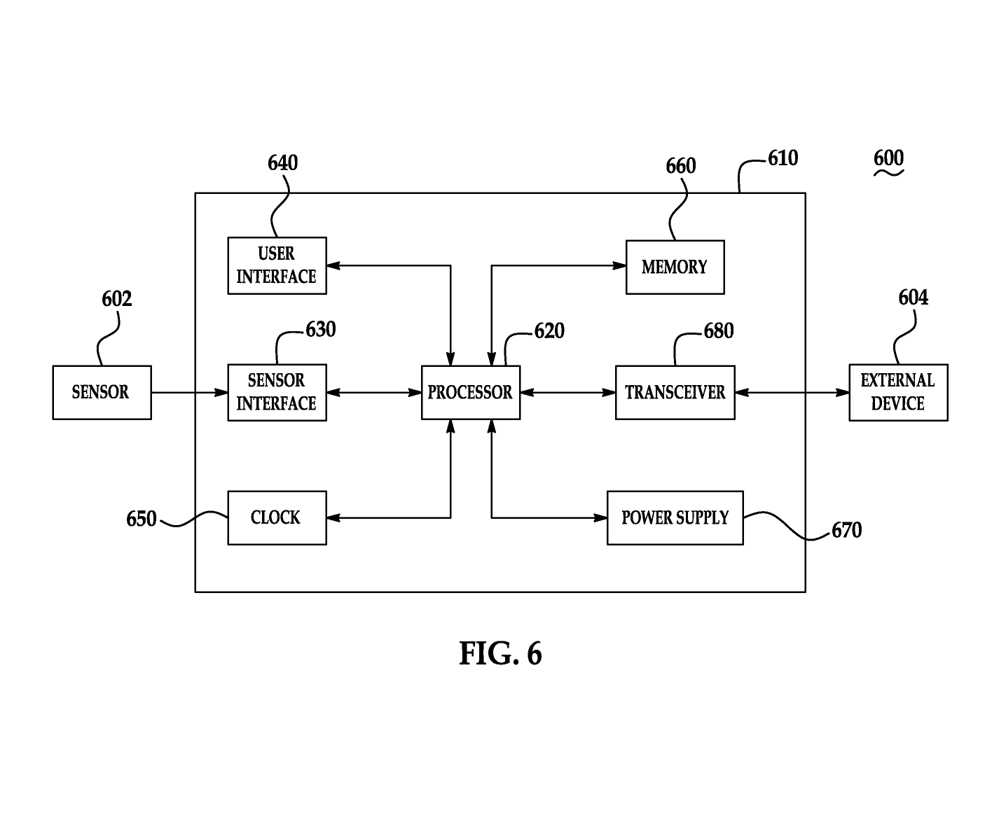

FIG. 6 shows a diagram of a health monitor device 600 in accordance with some embodiments of this disclosure. The health monitor device 600 may be used for determining a concentration of an analyte in blood or interstitial fluid. For example, the health monitor device 600 may be an analyte test meter, such as a glucose test meter that may be used for determining an analyte concentration, such as a blood glucose concentration, of a sample for determination of a blood glucose level of a patient, such as a patient with Type-1 or Type-2 diabetes. In some embodiments, the health monitor device 600 may be a blood glucose meter, a continuous monitor, an insulin pump, a blood pressure meter, a heart rate monitor, a thermometer, or any other health monitor device capable of measuring, monitoring, or storing raw or analyzed medical data electronically.

The health monitor device 600 may communicate in a wireless communication system, such as the wireless system shown in FIG. 1. For example, the health monitor device 600 may receive fluid samples, or sample data, from a sensor device 602, such as the test strip 101 shown in FIG. 1, and may wirelessly transmit data to an external device 604, such as the server device 104 shown in FIG. 1. The health monitor device 600 may include a housing 610, a processor 620, a sensor interface 630, a user interface 640, a clock 650, a data storage unit 660, a power supply 670, and a communication interface 680.

The housing 610 may physically enclose one or more of the processor 620, the sensor interface 630, the user interface 640, the clock 650, the data storage unit 660, the power supply 670, or the communication interface 680, and may be configured to fit into a small profile. Although the housing 610 is shown a single physical unit, the housing 610 may be implemented as one or more physical units that may be physically or electronically connected. Although not shown in FIG. 6, the housing 610 may include one or more ports, such as a test strip port, a power port, an audio connection port, or a data connection port. For example, the housing 610 may include a test strip port configured to receive a test strip, which may include a fluid sample, and may be connected to the sensor interface 630.

The processor 620 may include any device capable of manipulating or processing a signal or other information, including an optical processor, a quantum processor, a molecular processor, or a combination thereof. For example, the processor 620 may include a general purpose processor, a central processing unit (CPU), a special purpose processor, a plurality of microprocessors, a controller, a microcontroller, an Application Specific Integrated Circuit (ASIC), a Field Programmable Gate Array (FPGA), a programmable logic array, programmable logic controller, microcode, firmware, any type of integrated circuit (IC), a state machine, or any combination thereof. As used herein, the term “processor” includes a single processor or multiple processors. The processor 620 may be operatively coupled to the sensor interface 630, the user interface 640, the clock 650, the data storage unit 660, the power supply 670, or the communication interface 680.

In some embodiments, the sensor interface 630 may receive a fluid sample, such as a fluid sample transported via the test strip 101 shown in FIG. 1, and the processor 620 may control the sensor interface 630 to analyze the fluid sample to determine an associated analyte level. In some embodiments, the sensor interface 630 may receive raw or analyzed data indicating an analyte level associated with a fluid sample analyzed at an external measurement device, such as a continuous analyte monitoring device, via a wireless communication medium, such as radio frequency identification (RFID). For example, the continuous analyte monitoring device may include a transcutaneously implanted sensor, such as an implantable glucose sensor, that may continually or substantially continually measure an analyte concentration of a bodily fluid. In some embodiments, the sensor interface 630 may receive analyte related data from the external measurement device periodically, based on a transmission schedule, or may request the data from the external measurement device.

The user interface 640 may include a display unit and one or more input elements, such as buttons, jogs, or dials. The user interface 640, or a portion thereof, may be integrated with the housing 610. For example, the user interface 640 may form a part of an external surface of the housing 610. The user interface 640, or a portion thereof, may be configured to allow a user of the health monitor device 600 to receive information, input information, or otherwise interact, with the health monitor device 600. For example, the user of the health monitor device 600 may operate the one or more input buttons to enter a calibration code associated with a test strip or other fluid sample reception device. In another example, the user interface 640 may present visual, tactile, or auditory information indicating, for example, a blood glucose measurement to the user. In some embodiments, the display unit may include a graphical display unit, such as a LCD or an LED display, an auditory display unit, such as speaker, or both a graphical display and an audio display. In some embodiments, the user interface 640 may include a touch screen display. In some embodiments, the display unit, the input elements, or both may be omitted from the user interface 640.

The clock 650 may be operatively coupled to the processor 620 and may provide a clock signal at discreet clock frequencies to the processor 620. For example, the clock may include an oscillator, such as a quartz crystal oscillator, or any other device capable of producing a clock signal for indicating a real time clock.

The data storage unit 660 may store raw data, analyzed data, or both. In some embodiments, the data storage unit 660 may store instructions that may be executed by the processor to, for example, perform analysis, such as analyte concentration analysis and medication dosage calculation. The data storage unit 660 may include any non-transitory computer-usable or computer-readable medium, such as any tangible device that can, for example, contain, store, communicate, or transport instructions, or any information associated therewith, for use by or in connection with the processor 620. The non-transitory computer-usable or computer-readable medium may be, for example, a solid state drive, a memory card, removable media, a read only memory (ROM), a random access memory (RAM), any type of disk including a hard disk, a floppy disk, an optical disk, a magnetic or optical card, an application specific integrated circuits (ASICs), or any type of non-transitory media suitable for storing electronic information, or any combination thereof. The data storage unit 660 may be operatively connected to, for example, the processor 620 through, for example, a memory bus.

The power supply 670 may be any suitable device for powering the health monitor device 600, or any portion thereof. For example, the power supply 670 may include a wired power source; one or more dry cell batteries, such as nickel-cadmium (NiCd), nickel-zinc (NiZn), nickel metal hydride (NiMH), lithium-ion (Li-ion); solar cells; fuel cells; or any other device capable of powering the health monitor device 600. The processor 620, the sensor interface 630, the user interface 640, the clock 650, the data storage unit 660, or the communication interface 680, may be operatively coupled to the power supply 670.

The communication interface 680 may communicate with an external device 604, such as the sever 104 shown in FIG. 1 and FIG. 4. For example, the communication interface 680 may be an RF transmitter, such as the RF transmitter 206 shown in FIG. 2, and may communicate using a wireless communication protocol, such as an 802.11 protocol, a Bluetooth® RF protocol, a cellular protocol, or any other wireless protocol. In some embodiments, the communication interface 680 may include a receiver, a transmitter, or a transceiver. For example, the communication interface 680 may include a wireless transmission unit, such as a Bluetooth® low energy wireless transmission unit. Although not expressly shown in FIG. 6, the communication interface 680 may include a wireless antenna, a wired communication port, such as an Ethernet port, an infrared port, a serial port, or any other wired or wireless unit capable of interfacing with a wired or wireless electronic communication medium. In some embodiments, the health monitor device 600 may communicate with the external device 604 indirectly via another device, or series of devices. For example, the health monitor device 600 may communicate with the external device 604 via a network, wherein the health monitor device 600 may transmit signals to, for example, an access point (not shown), and the access point may transmit the signals to the external device 604, in the same or a different format, via one or more other devices in a network.

In some embodiments, the communication interface 680 may communicate with the external device 604 using a low energy wireless communication protocol, such as Bluetooth® low energy. Communicating using a low energy wireless communication protocol may allow the communication interface 680 to use substantially less power than communicating using other wireless communication protocols, such as other versions of Bluetooth®. For example, using a low energy wireless communication protocol, the communication interface 680 may have a lower duty cycle and may actively operate less frequently, for shorter periods of time, or both.

In some embodiments, the processor 610, the communication interface 680, or a combination of the processor 610 and the communication interface 680, may determine whether to use a wireless communication protocol, such as Bluetooth®, or a low energy wireless communication protocol, such as Bluetooth® low energy. For example, the processor 610 may determine which wireless communication protocol to use based on network conditions, battery conditions, sensed data, or a combination thereof.

In some embodiments, the health monitor device 600 may audibly present information, such as information indicating an analyte concentration, information indicating a rate of change of an analyte concentration, or information indicating the exceeding of a threshold of an analyte concentration, which may indicate, for example, hypo- or hyperglycemia. For example, the user interface 640 may include a speaker, and the health monitor device 600 may present the audio signal via the speaker. In some embodiments, the health monitor device 600 may transmit raw or analyzed analyte information to the external device 604 and the external device 604 may generate an audio signal for presentation. In some embodiments, the health monitor device 600 may generate an audio signal indicating the information and may transmit the audio indication to the external device 604 for audio presentation.

Although shown as separate elements, the processor 620, the sensor interface 630, the user interface 640, the clock 650, the data storage unit 660, the power supply 670, the communication interface 680, or any combination thereof, may be integrated in one or more electronic units, circuits, or chips.

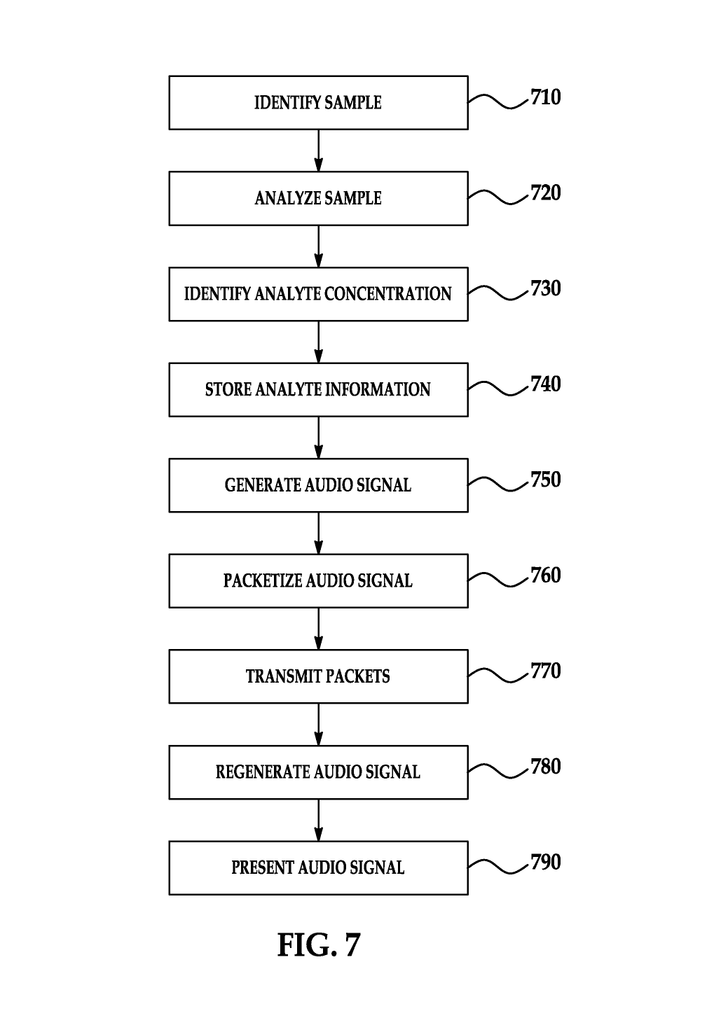

FIG. 7 shows an example of transmitting an audio indication of health monitoring information using a low energy wireless communication protocol in accordance with some embodiments of this disclosure. For example, a health monitor device, such as the health monitor device 600 shown in FIG. 6, may transmit an audio indication of health monitoring information, such as analyte information, using a low energy wireless communication protocol. Transmitting an audio indication of health monitoring information using a low energy wireless communication protocol may include identifying a sample at 710, analyzing the sample at 720, identifying an analyte concentration at 730, storing analyte information at 740, generating an audio signal at 750, packetizing the audio signal at 760, transmitting the packetized audio signal at 770, regenerating the audio signal at 780, presenting the audio signal at 790, or a combination thereof.

A sample, such as a blood sample, may be identified at 710. For example, the health monitor device may include a sensor interface, such as the sensor interface 630 shown in FIG. 6, configured to receive a receive a fluid sample, such as a fluid sample transported via a test strip, such as the test strip 101 shown in FIG. 1. In some embodiments, the sample may be identified by an external measurement device, such as a continuous analyte monitoring device, configured to communicate with the health monitor device using, for example, a short range wireless communication method, such as RFID. For example, the continuous analyte monitoring device may include a transcutaneously implanted sensor that may continually or substantially continually measure an analyte concentration of a bodily fluid.

The sample may be analyzed to determine a corresponding analyte level, such as a glucose level, at 720. For example, the health monitor device may include a processor, such as the processor 620 shown in FIG. 6, configured to analyze the sample. In some embodiments, the sample may be analyzed by an external analysis device, such as a continuous analyte monitoring device, configured to communicate with the health monitor device.

An analyte concentration may be identified at 730. For example, the analyte concentration may be identified based on the sample analysis at 720. In some embodiments, the analyte concentration may be received from an external analysis device, such as a continuous analyte monitoring device, configured to communicate with the health monitor device. In some embodiments, the analyte concentration may be identified based on stored information, such as previously stored raw or analyzed sample data.

In some embodiments, raw or analyzed analyte information, such the analyte concentration identified at 730, may be stored at 740. For example, health monitor device may include a data storage unit, such as the memory 660 shown in FIG. 6, a processor, such as the processor 620 shown in FIG. 6, a sensor interface, such as the sensor interface 630 shown in FIG. 6, or a combination thereof, and the processor, the sensor interface, or a combination thereof, may identify the analyte concentration based on raw or analyzed analyte data stored on the data storage unit.

An audio signal may be generated based on the analyte concentration at 750. Generating the audio signal may include generating a voice output or sound tones. The voice output or may be configured to provide an audible indication of information including, for example, analyte concentration, rate of change of analyte concentration, or the exceeding of a threshold analyte concentration. In some embodiments, the audio signal may be stored on the health monitor device, such as on a data storage unit in the health monitor device.

The voice output may be generated using a synthesized voice, a pre-recorded voice, or a combination of a synthesized voice and a pre-recorded voice. For example, the voice output may be generated based on a set of pre-recorded terms stored on the health monitor device and any terms not included in the set of pre-recorded may be provided by a voice synthesizer. In some embodiments, the health monitor device may include pre-recorded terms in one or more languages and generating the audio signal may include using pre-recorded terms, a synthesized voice, or both, in a specified language. In some embodiments, the health monitor device may provide for voice output selection, which may be configured to allow the selection of various aspects of the voice output, such as, volume of the voice output, gender of the spoken voice, or language of the spoken voice.

In some embodiments, generating a voice output may include modulating the audio stream to use tone of voice to indicate urgency. For example, a healthy blood glucose level may be presented using a normal tone of voice and an unhealthy blood glucose level, such as a level indicating hypoglycemia or hyperglycemia, may be presented in an urgent tone of voice.

In some embodiments, generating the audio signal may include generating voice output of audio instructions. For example, the voice output may include audio instructions indicating how to clear an occlusion, or instructions to drink fruit juice to recover from hypoglycemia. In another example, the voice output may include audio instructions to assist the patient in gathering information for determining an adjusted dose level, such as an adjusted dose level for long-acting insulin based on fasting blood glucose levels. The audio instructions may indicate a series of actions, including, but not limited to, fasting and blood glucose tests, re-testing, insulin injections and food intake

Although FIG. 7 shows presenting an audio signal in conjunction with analyzing an analyte sample, an audio signal may be generated and presented independently of sample analysis. For example, an audio signal may be generated and presented to audibilize an alarm that is not related to sample measurement, or to present a reminder. For example, the health monitor device may allow entry and storage of reminders, such as a periodic reminder to perform sample analysis, and an audio signal may be generated and presented to audibilize the reminders.

The audio signal may be packetized at 760. For example, the health monitor device may be configured to communicate the audio signal to an external device using a low energy wireless communication protocol, such as Bluetooth® low energy, which may not support transmission of an audio signal. In order to transmit the audio signal using a wireless communication protocol that does not support transmission of an audio signal, such as via audio streaming, the health monitor device may packetize the audio signal into a series of packets, which may be referred to as application layer packets, in a format that is supported by the wireless communication protocol. In some embodiments, the wireless communication protocol may support audio transmission and packetization may be omitted.

The audio signal may be transmitted to an external device at 770. For example, the health monitor device may include a communication unit, such as the transceiver 680 shown in FIG. 6, and the audio signal may be transmitted to an external device, such as the external device 604 shown in FIG. 6. For example, the packets generated by packetizing the audio signal at 760 may be transmitted to the external device using a low energy wireless communication protocol, such as Bluetooth® low energy. Transmitting the packetized audio signal may include performing signal processing, such as transport and physical layer packetization.

The wireless communication may be received by the external device and the audio signal may be regenerated at 780. For example, the external device may receive a signal using a low energy wireless communication protocol, such as Bluetooth® low energy. The received signal may include the packetized audio signal. The external device may recover the application layer packets from the received signal and may combine the application layer packets to regenerate the audio signal.

The audio signal may be presented at 790. For example, the external device may be a wireless headset, a car stereo, a television, a set top box, or any other device, or combination of devices, capable of receiving the wireless communication and audibly presenting the audio signal.

Various other modifications and alterations in the structure and method of operation of this invention will be apparent to those skilled in the art without departing from the scope and spirit of the invention. Although the invention has been described in connection with specific preferred embodiments, it should be understood that the invention as claimed should not be unduly limited to such specific embodiments. It is intended that the following claims define the scope of the present invention and that structures and methods within the scope of these claims and their equivalents be covered thereby.

What is claimed is:

1. A device comprising:
a housing;
a processor coupled to the housing;
a low energy wireless transmission unit; and
a memory device coupled to the housing and the processor, wherein the memory device comprises instructions which, when executed by the processor, cause the processor to:
detect an analyte sample;
determine an analyte concentration associated with the detected analyte sample;
cause the low energy wireless transmission unit to transmit an indication of the analyte concentration to an external device.

2. The device of claim 1, wherein the low energy wireless transmission unit includes a Bluetooth® low energy unit.

3. The device of claim 1, wherein the indication of the analyte concentration includes a value indicating the analyte concentration.

4. The device of claim 1, wherein the memory device includes instructions to cause the processor to generate an audio indication of the analyte concentration, wherein the indication of the analyte concentration includes the audio indication.

5. The device of claim 4, wherein the memory device includes instructions to cause the processor to packetize the audio indication to generate a plurality of application layer packets such that each packet in the plurality of application layer packets includes a portion of the audio indication; and wherein causing the low energy wireless transmission unit to transmit the indication of the analyte concentration includes causing the low energy wireless transmission unit to transmit the plurality of application layer packets such that the external device can present the audio indication.

6. The device of claim 4, wherein the audio indication includes a voice output.

7. The device of claim 6, wherein the memory device includes instructions to cause the processor to generate the voice output such that a tone of voice of the voice output indicates a degree of urgency.

8. The device of claim 1, wherein the memory device includes instructions to cause the processor to cause the low energy wireless transmission unit to transmit the indication of the analyte concentration to the external device using a low energy wireless transmission protocol.

9. The device of claim 1, wherein the external device is a wireless headset, a car stereo, a television, or a set top box.

10. The device of claim 1, wherein the memory device includes instructions to cause the processor to detect the analyte sample by receiving an indication of the analyte sample, and to determine the analyte concentration associated with the detected analyte sample by receiving an indication of the analyte concentration.

11. A method comprising:
detecting an analyte sample;
determining an analyte concentration associated with the detected analyte sample; and
transmitting an indication of the analyte concentration to an external device using a low energy wireless communication protocol.

12. The method of claim 11, wherein the low energy wireless communication protocol includes a Bluetooth® low energy wireless communication protocol.

13. The method of claim 11, wherein the indication of the analyte concentration includes a value indicating the analyte concentration.

14. The method of claim 11, further comprising:
generating an audio indication of the analyte concentration, wherein the indication of the analyte concentration includes the audio indication.

15. The method of claim 14, further comprising:
packetizing the audio indication to generate a plurality of application layer packets such that each packet in the plurality of application layer packets includes a portion of the audio indication; and wherein transmitting the indication of the analyte concentration includes transmitting the plurality of application layer packets such that the external device can present the audio indication.

16. The method of claim 14, wherein the audio indication includes a voice output.

17. The method of claim 16, wherein generating the voice output includes generating the voice output such that a tone of voice of the voice output indicates a degree of urgency.

18. The method of claim 16, wherein the external device is a wireless headset, a car stereo, a television, or a set top box.

19. The method of claim 16, detecting the analyte sample includes receiving an indication of the analyte sample, and determining the analyte concentration associated with the detected analyte sample includes receiving an indication of the analyte concentration.
